(19) United States
(12) Patent Application Publication
(10) Pub. No.: US 2022/0408793 A1
(43) Pub. Date: Dec. 29, 2022

(54) METHOD FOR PREPARING TAR EXTRACT FROM DISCARDED CIGARETTE BUTTS AND APPLICATION THEREOF IN CIGARETTES

(71) Applicant: INNER MONGOLIA KUNMING CIGARETTE CO., LTD., Hohhot (CN)

(72) Inventors: Liqun LI, Hohhot (CN); Chunsheng GUO, Hohhot (CN); Xudong JI, Hohhot (CN); Junsong ZHANG, Hohhot (CN); Chen CHEN, Hohhot (CN); Yajun YE, Hohhot (CN); Jie HAO, Hohhot (CN); Xudong WANG, Hohhot (CN); Yuemei QIAO, Hohhot (CN); Ruili LI, Hohhot (CN); Miao LIANG, Hohhot (CN); Wenjie ZHANG, Hohhot (CN)

(73) Assignee: INNER MONGOLIA KUNMING CIGARETTE CO., LTD., Hohhot (CN)

(21) Appl. No.: 17/780,552

(22) PCT Filed: Nov. 16, 2020
(86) PCT No.: PCT/CN2020/129088

§ 371 Date: May 27, 2022

(30) Foreign Application Priority Data
Nov. 27, 2019 (CN) 201911179717.6

(51) Int. Cl. A24B 15/26; B01D 15/42; B01D 3/10; A24B 3/12; B01D 21/26; A24D 3/14

(52) U.S. Cl. CPC A24B 15/26; B01D 15/426; B01D 3/10; A24B 3/12; B01D 21/262; A24D 3/14

(57) ABSTRACT

A method for preparing a tar extract from a discarded cigarette butt and use of the tar extract in a cigarette includes the following steps: (1) adding the discarded cigarette butt to an extraction solvent, and carrying out microwave-assisted extraction to obtain an extraction solution; and (2) centrifuging the extraction solution, carrying out silica gel column chromatography on the supernatant, carrying out elution by using a petroleum ether-ethyl acetate mixed solution as a mobile phase, and collecting the resulting elution fraction to obtain the tar extract. In the method, the tar is extracted from the discarded cigarette butt as a raw material. Through the microwave-assisted extraction and separation by the silica gel column chromatography, harmful substances in the tar of the cigarette butt are removed, and the components with aroma characteristics are retained, and the tar extract is applied to a low-end cigarette.

### CROSS REFERENCE TO THE RELATED APPLICATIONS

This application is the national phase entry of International Application No. PCT/CN2020/129088, filed on Nov. 16, 2020, which is based upon and claims priority to Chinese Patent Application No. 201911179717.6, filed on Nov. 27, 2019, the entire contents of which are incorporated herein by reference.

### TECHNICAL FIELD

The present disclosure relates to a method for preparing a tar extract from a discarded cigarette butt and use of the tar extract in a cigarette, belonging to the technical field of tobacco technology.

### BACKGROUND

A cigarette is a tobacco product in which a tobacco blend is rolled into strips with cigarette paper. The cigarette is mainly composed of a tobacco blend, cigarette paper, tipping paper and a filter. The cigarette paper (also known as bobbin paper) is special paper used for wrapping the tobacco blend. The tipping paper (also known as cork paper bobbin) is special paper used for uniting a tobacco rod with the filter. The tipping paper and the filter section make up a cigarette butt. The cigarette butt is a residual part of a cigarette after smoking. The cigarette butt is composed of outer wrapping paper and an inner fiber tow. The fiber tow of the cigarette butt has an adsorption capacity and can effectively trap tar and other harmful particles in the smoke.

China consumes a large number of cigarettes every year, and then a large number of discarded cigarette butts are produced, causing great pollution to the environment. The discarded cigarette butts contain a large amount of tar. Cigarette tar contains not only aroma components that have a positive effect on sensory quality, such as ketones, furans and pyrazines, but also nicotine that can improve consumers' physiological satisfaction, and harmful substances that have an obvious negative effect on sensory quality, such as amines and aldehydes. Therefore, it is of great significance to extract tar in the discarded cigarette butts and prepare an extract with certain properties or effects.

CN109959649A discloses a cigarette tar extract with chemiluminescent properties. A method of preparing the cigarette tar extract includes the step of: adding cigarette tar to a reagent for extraction to obtain the cigarette tar extract. The cigarette tar may be obtained by the following steps: smoking a cigarette, filtering the generated smoke, and collecting smoke particulate matters to obtain the cigarette tar. The cigarette tar extract in this patent is obtained by ultrasound-assisted extraction in an open system under natural light conditions, so a luminescent substance contained has stable properties and are insensitive to light, oxygen and temperature, etc. This extract has a wide luminescence response range for pH of a medium, and is capable of being subjected to a chemiluminescent reaction under acidic, neutral or alkaline conditions. In this patent, the cigarette tar is the tar in the smoke particulate matters, and the prepared tar extract is luminescent, so this patent does not involve extraction of tar in the discarded cigarette butt to obtain the extract with aroma characteristics.

CN102559388A discloses a tobacco essential oil and a method for preparing the same, and use of the tobacco essential oil in cigarettes. The tobacco essential oil is prepared by the following method including: taking discarded/defective tobacco wastes, carrying out extraction with an organic solvent, obtaining a crude extract of essential oil, introducing water vapor, carrying out condensation, and separating oil and water to obtain the tobacco essential oil. In this patent, the tobacco essential oil is added to a cigarette tobacco blend as an aroma enhancer, and can enhance the original aroma of tobacco, improve the aroma quality and quantity of cigarettes, reduce the irritancy and offensive odor of the tobacco and soften the smoke. The discarded/defective tobacco wastes produced in the cigarette production process, which are used as a raw material, are free of tar, so this patent does not involve an extraction process for the discarded cigarette butt.

### SUMMARY

The present disclosure aims to provide a method for preparing a tar extract from a discarded cigarette butt and use of the tar extract in a cigarette. By using the discarded cigarette butt as a raw material, microwave-assisted extraction and separation by silica gel column chromatography are used to obtain the tar extract with aroma characteristics, and the obtained tar extract is applied to the cigarette to enhance the aroma of the cigarette.

In the present disclosure, the discarded cigarette butt used as a raw material is discarded by people on the roadside or in an ashtray, so the method has the advantages of wide raw material sources and low cost. A yellow cigarette butt is selected due to its higher tar content.

In one aspect, the present disclosure provides a method for preparing a tar extract from a discarded cigarette butt, including the following steps:

(1) adding the discarded cigarette butt to an extraction solvent, and carrying out microwave-assisted extraction to obtain an extraction solution; and

(2) centrifuging the extraction solution, carrying out silica gel column chromatography on the supernatant, carrying out elution by using a petroleum ether-ethyl acetate mixed solution as a mobile phase, and collecting the resulting elution fraction to obtain the tar extract.

Further, in the step (1), the extraction solvent is at least one of methanol, anhydrous ethanol, petroleum ether, n-hexane, acetone, dichloromethane and ethyl acetate.

Preferably, a ratio of the discarded cigarette butt to the extraction solvent is 1 g:5-30 mL, a microwave-assisted extraction power is 40-400 W, and the microwave-assisted extraction is carried out for 3-10 min. Preferably, the microwave-assisted extraction power is 50-200 W, a lower limit of the microwave-assisted extraction power is selected from 60 W, 70 W, 80 W, 90 W, 100 W, 110 W, 120 W, 130 W, 140 W, 150 W, 160 W, 170 W, 180 W or 190 W, and an upper limit of the microwave-assisted extraction power is selected from 60 W, 70 W, 80 W, 90 W, 100 W, 110 W, 120 W, 130 W, 140 W, 150 W, 160 W, 170 W, 180 W or 190 W More preferably, the microwave-assisted extraction is carried out for 4-9 min, a lower limit of the microwave-assisted extraction time is selected from 5 min, 6 min, 7 min or 8 min, and an upper limit of the microwave-assisted extraction time is selected from 5 min, 6 min, 7 min or 8 min.

Further, in the step (2), a volume ratio of petroleum ether to ethyl acetate in the petroleum ether-ethyl acetate mixed solution is 2-30:1 (v/v).

The centrifuging is carried out at a revolution speed of 500-2000 r/min for 1-3 min.

Further, the method further includes the steps of carrying out vacuum distillation on the collected elution fraction, and carrying out vacuum drying.

Preferably, the vacuum distillation is carried out at a temperature of 30-50° C. under a pressure of 0.1-5 mmH; and the drying is carried out at a temperature of 100-150° C.

Further, the method further includes a step of pretreating the discarded cigarette butt.

Preferably, the pretreating specifically includes: tearing off outer wrapping paper from the discarded cigarette butt, and cutting a tow into small segments with a length of less than 1 cm.

In another aspect, the present disclosure further provides a tar extract prepared by the method.

In still another aspect, the present disclosure further provides use of the tar extract as a raw material of a flavor or in the preparation of a flavor.

In yet another aspect, the present disclosure further provides use of the tar extract in the preparation of a cigarette.

Preferably, the cigarette is a low-end cigarette.

Preferably, the tar extract is added to a filter or a tobacco blend of the cigarette. Preferably, the amount of the tar extract added is 2-5% of the weight of the cigarette tobacco blend.

The present disclosure has the following beneficial effects:

(1) Through the microwave-assisted extraction and separation by the silica gel column chromatography, harmful substances in the tar of the cigarette butt are removed, and the components with aroma characteristics are retained, and the tar extract is applied to the low-end cigarette to improve the aroma, smoke and taste characteristics of the low-end cigarette and also improve the sensory quality of the low-end cigarette, thereby increasing the use proportion of inferior tobacco leaves in the cigarette or widening the use ways of the inferior tobacco leaves, and providing ideas and technical support for reducing the inventory pressure of the inferior tobacco leaves.

(2) By optimizing the conditions of the microwave-assisted extraction and separation by the silica gel column chromatography, the tar extract is extracted from the cigarette butt at a higher yield. The discarded cigarette butt is used as the raw material, which can not only avoid the cigarette butt from polluting the environment, but also make use of a byproduct tar after smoking the cigarette.

### DETAILED DESCRIPTION OF THE EMBODIMENTS

The present disclosure will be described in detail in conjunction with specific examples. The following examples are only explanations for those skilled in the art to understand the technical solution of the present disclosure and to realize or use the present disclosure, and are not intended to limit the protection range of the present disclosure.

Unless otherwise specified, the raw materials and equipment used in the present disclosure are those available from the market or commonly used in the art.

The methods in the examples, unless otherwise specified, are conventional methods in the art.

### EXAMPLE 1

A method for preparing a tar extract from a discarded cigarette butt included the following steps:

(1) pretreating of the discarded cigarette butt: outer wrapping paper of the discarded cigarette butt was removed, and a tow was cut into small segments with a length of less than 1 cm;

(2) 100 g of the pretreated discarded cigarette butt was added to 1 L of petroleum ether, and microwave irradiation was carried out with a microwave-assisted extraction power of 80 W for 5 min to obtain an extraction solution;

(3) the extraction solution was centrifuged at 1200 r/min for 2 min, the supernatant was allowed to pass through a silica gel column, elution was carried out by using a petroleum ether-ethyl acetate mixed solution (a volume ratio of petroleum ether to ethyl acetate was 20:1) as a mobile phase, and the resulting elution fraction was collected; and

(4) vacuum distillation was carried out on the elution fraction at 45° C. under a vacuum pressure of 1 mmH, and then vacuum drying was carried out at 120° C. to obtain the tar extract.

The tar extract was detected by GC/MS. Main components in the tar extract were furfural, furfuryl alcohol, ethylene glycol diacetate, 1-(1,3-dioxolan-2-yl)acetone, 4-cyclopentene-1,3-dione, methylcyclopentenolone, nicotine, 2-acetylfuran, 2(5H)-furanone, 5-methylfurfural, 3-methyl-2-cyclopenten-1-one, methylcyclopentenolone, benzyl alcohol, 2,3-dimethyl-2-cyclopentenone, ethylcyclopentenolone, 5-hydroxymethylfurfural, vanillin, megastigmatrienone A, 2,4,4-trimethylpentane-1,3-diyl bis(2-methylpropionate), farnesol, phthalic acid 1-butyl 2-isobutyl ester, scopoletin and tributyl prop-1-ene-1,2,3-tricarboxylate.

### GC/MS Conditions

HP 6890/5973 GC-MS

### (1) GC Conditions

Chromatographic column: ULTRA2 (50 m×0.2 mm i.d×0.33 μm d.f.)

Detector: MS

Carrier gas, flow rate: He, 0.6 ml/min

Temperature of injection port: 290° C.

Temperature program: 80° C. (1 min) 2° C./min→280° C. (10 min)

Split ratio, injection volume: 1:10, 2 μl

### (2) Conditions of GC/MS

GC conditions: the same as above

Temperature of transfer line: 230° C.

Temperature of ion source: 230° C.

Ionization energy: 70 eV

Mass range: 30-350 u

Carrier gas: He

MS spectra: NIST Library

### EXAMPLE 2 USE OF TAR EXTRACT IN CIGARETTE

The tar extract prepared in Example 1 was added to a cigarette tobacco blend in an amount of 3% of the weight of the cigarette tobacco blend to prepare a cigarette sample 1.

The tar extract prepared in Example 1 was added to a cigarette tobacco blend in an amount of 5% of the weight of the cigarette tobacco blend to prepare a cigarette sample 2.

The tar extract prepared in Example 1 was added to a cigarette tobacco blend in an amount of 2% of the weight of the cigarette tobacco blend to prepare a cigarette sample 3.

After the cigarette samples prepared by the above solution and a cigarette without the tar extract were equilibrated in a constant-temperature and constant-humidity environment of (20±1)° C. and (60±3)% RH for 24 h, 10 or more smoking evaluators were organized to perform sensory evaluation on the cigarette samples with reference to Tobacco in processing-Sensory evaluation methods (YC/T 415-2011). The evaluation results are shown in Table 1.

TABLE 1
Sensory evaluation results

| | | Control | Sample | Sample | Sample |
|---|---|---|---|---|---|
| Evaluation sample | | sample | 1 | 2 | 3 |
| Aroma | Quality of aroma | 6.0 | 6.25 | 6.50 | 6.50 |
| characteristics | Quantity of aroma | 6.0 | 6.30 | 6.50 | 6.50 |
| | Offensive odor | 6.0 | 6.25 | 6.50 | 6.50 |
| | Volatility | 5.5 | 6.00 | 5.65 | 6.00 |
| Smoke | Concentration | 6.0 | 6.25 | 6.25 | 6.50 |
| characteristics | Strength | 5.5 | 5.80 | 5.80 | 5.80 |
| | Harshness | 5.5 | 5.80 | 6.00 | 6.00 |
| | Agglomeration | 5.5 | 5.50 | 5.80 | 6.00 |
| Taste | Irritancy | 5.5 | 6.00 | 6.00 | 6.00 |
| characteristics | Dry feeling | 5.5 | 5.75 | 6.00 | 6.00 |
| | Clean degree | 5.5 | 5.5 | 5.75 | 5.75 |
| | Sweet aftertaste | 4.0 | 5.0 | 5.0 | 5.0 |

As shown in Table 1, compared with the control group, after the tar extract prepared in the example of the present disclosure was added, the aroma characteristics of the cigarettes changed greatly, among which the scores of the quality of aroma, the quantity of aroma, the offensive odor and the volatility were increased to different degrees, showing obvious improvement effects. Among the smoke characteristics, the concentration and the strength were slightly increased, and the harshness and the agglomeration of the smoke were improved. Among the taste characteristics, the sweet aftertaste was increased, the moist feeling was increased, the dry feeling was decreased, the irritancy was reduced significantly. As a result, the smoke, aroma and taste characteristics of the low-end cigarette were effectively improved, and the sensory quality of the low-end cigarette was improved.

### EXAMPLE 3 SELECTION OF CONDITIONS FOR PREPARATION METHOD

### 1. Selection of Extraction Solvent

Methanol, dichloromethane, anhydrous ethanol, glycerin, petroleum ether and polyethylene glycol 400 were respectively used to carry out extraction by microwave irradiation on the pretreated discarded cigarette butt, wherein a ratio of material to liquid was 1:10 (g/mL), and the extraction by microwave irradiation was carried out once with a microwave-assisted extraction power of 80 W for 5 min. The effects of different solvents on extraction effects (the amounts of components extracted from per g of cigarette butt) were compared and analyzed. The detection results of the extraction solutions are shown in Table 2. As can be seen from Table 2, the anhydrous ethanol had the best extraction effects.

TABLE 2
Extraction effects of different organic solvents (mg/g)

| | | | Extraction solvent | | | | | |
|---|---|---|---|---|---|---|---|---|
| | Holding | | | Dichloro | Anhydrous | | Petroleum | Polyethylene |
| No. | time/min | Component | Methanol | methane | ethanol | Glycerin | ether | glycol 400 |
| 1 | 11.087 | Furfural | 0.97 | 0.93 | 1.08 | 0.47 | 0.94 | 0.41 |
| 2 | 11.963 | Furfuryl alcohol | 1.01 | 0.99 | 1.15 | 0.53 | 0.88 | 0.38 |
| 3 | 12.428 | Ethylene glycol | 0.50 | 0.49 | 0.53 | 0.25 | 0.43 | 0.24 |
| | | diacetate | | | | | | |
| 4 | 13.016 | 1-(1,3-dioxolan- | 0.48 | 0.51 | 0.53 | 0.21 | 0.47 | 0.26 |
| | | 2-yl)acetone | | | | | | |
| 5 | 13.258 | 4-cyclopentene-1, | 0.47 | 0.42 | 0.51 | 0.2 | 0.39 | 0.21 |
| | | 3-dione | | | | | | |
| 6 | 14.240 | Methylcyclopentenolone | 0.46 | 0.40 | 0.46 | 0.21 | 2.09 | 0.19 |
| 7 | 14.406 | Nicotine | 2.27 | 2.20 | 2.36 | 1.12 | 2.06 | 0.77 |
| 8 | 14.446 | 2-acetylfuran | 0.23 | 0.24 | 0.30 | 0.14 | 0.26 | 0.14 |
| 9 | 14.646 | 2(5H)-furanone | 0.34 | 0.39 | 0.42 | 0.17 | 0.40 | 0.18 |
| 10 | 16.934 | 5-methylfurfural | 1.47 | 1.50 | 1.60 | 0.73 | 1.44 | 0.63 |
| 11 | 17.051 | 3-methyl-2- | 0.81 | 0.77 | 0.94 | 0.41 | 0.79 | 0.35 |
| | | cyclopenten-1-one | | | | | | |
| 12 | 20.257 | Methylcyclopentenolone | 1.47 | 1.51 | 1.71 | 0.69 | 1.47 | 0.62 |
| 13 | 20.545 | Benzyl alcohol | 0.44 | 0.41 | 0.48 | 0.22 | 0.40 | 0.21 |
| 14 | 20.745 | 2,3-dimethyl-2- | 1.18 | 1.05 | 1.25 | 0.62 | 1.08 | 0.48 |
| | | cyclopentenone | | | | | | |
| 15 | 24.792 | Ethylcyclopentenolone | 0.50 | 0.44 | 0.54 | 0.23 | 0.41 | 0.23 |
| 16 | 30.262 | 5 -hydroxymethyl | 1.25 | 1.20 | 1.30 | 0.55 | 1.18 | 0.44 |
| | | furfural | | | | | | |
| 17 | 37.938 | Vanillin | 0.68 | 0.69 | 0.73 | 0.35 | 0.67 | 0.32 |
| 18 | 45.367 | Megastigmatrienone A | 0.99 | 0.85 | 1.03 | 0.49 | 0.91 | 0.42 |
| 19 | 45.820 | 2,4,4-trimethylpentane- | 0.53 | 0.49 | 0.58 | 0.29 | 0.54 | 0.28 |
| | | 1,3-diylbis(2- | | | | | | |
| | | methylpropionate) | | | | | | |
| 20 | 56.972 | Farnesol | 0.45 | 0.42 | 0.51 | 0.25 | 0.45 | 0.25 |
| 21 | 58.684 | Phthalic acid | 0.69 | 0.76 | 0.77 | 0.36 | 0.71 | 0.34 |
| | | 1-butyl | | | | | | |
| | | 2-isobutyl ester | | | | | | |
| 22 | 59.096 | Scopoletin | 0.52 | 0.60 | 0.61 | 0.29 | 0.60 | 0.28 |
| 23 | 64.684 | Tributyl | 0.53 | 0.61 | 0.60 | 0.28 | 0.59 | 0.24 |
| | | prop-1-ene-1,2,3- | | | | | | |
| | | tricarboxylate | | | | | | |

| | | | | | | |
|---|---|---|---|---|---|---|
| Total amount | 18.25 | 17.87 | 19.99 | 9.06 | 19.15 | 7.87 |

### 2. Selection of Microwave Radiation Time

100 g of the pretreated discarded cigarette butt was added to 1 L of anhydrous ethanol, microwave-assisted extraction was carried out by respectively microwave radiation for 1, 3, 5, 9 and 12 min, and the extraction effects were tested. The detection results are shown in Table 3. As can be seen from Table 3, the extraction effect was best under microwave irradiation for 5 min.

TABLE 3
Extraction effects of different microwave radiation times (mg/g)

| | | | Extraction time | | | | |
|---|---|---|---|---|---|---|---|
| No. | Holding time | Component | 1 min | 3 min | 5 min | 9 min | 12 min |
| 1 | 11.087 | Furfural | 0.74 | 0.85 | 1.08 | 1.05 | 0.65 |
| 2 | 11.963 | Furfuryl alcohol | 0.78 | 0.97 | 1.15 | 1.08 | 0.52 |
| 3 | 12.428 | Ethylene glycol | 0.36 | 0.45 | 0.53 | 0.51 | 0.32 |
| | | diacetate | | | | | |
| 4 | 13.016 | 1-(1,3-dioxolan-2-yl) | 0.35 | 0.41 | 0.53 | 0.48 | 0.33 |
| | | acetone | | | | | |
| 5 | 13.258 | 4-cyclopentene-1,3-dione | 0.36 | 0.45 | 0.51 | 0.43 | 0.34 |
| 6 | 14.240 | Methylcyclopentenolone | 0.31 | 0.40 | 0.46 | 0.42 | 0.32 |
| 7 | 14.406 | Nicotine | 1.62 | 1.92 | 2.36 | 2.14 | 1.15 |
| 8 | 14.446 | 2-acetylfuran | 0.21 | 0.27 | 0.30 | 0.26 | 0.18 |
| 9 | 14.646 | 2(5H)-furanone | 0.29 | 0.32 | 0.42 | 0.40 | 0.31 |
| 10 | 16.934 | 5-methylfurfural | 1.08 | 1.30 | 1.60 | 1.53 | 0.75 |
| 11 | 17.051 | 3-methyl-2-cyclopenten-1-one | 0.65 | 0.70 | 0.94 | 0.94 | 0.38 |
| 12 | 20.257 | Methylcyclopentenolone | 1.15 | 1.43 | 1.71 | 1.69 | 0.87 |
| 13 | 20.545 | Benzyl alcohol | 0.33 | 0.38 | 0.48 | 0.48 | 0.25 |
| 14 | 20.745 | 2,3-dimethyl-2-cyclopentenone | 0.84 | 1.00 | 1.25 | 1.07 | 0.62 |
| 15 | 24.792 | Ethylcyclopentenolone | 0.39 | 0.40 | 0.54 | 0.47 | 0.27 |
| 16 | 30.262 | 5-hydroxymethylfurfural | 0.90 | 1.07 | 1.30 | 1.18 | 0.69 |
| 17 | 37.938 | Vanillin | 0.50 | 0.54 | 0.73 | 0.71 | 0.48 |
| 18 | 45.367 | Megastigmatrienone A | 0.75 | 0.89 | 1.03 | 1.03 | 0.67 |
| 19 | 45.820 | 2,4,4-trimethylpentane- | 0.41 | 0.50 | 0.58 | 0.50 | 0.18 |
| | | 1,3-diylbis(2- | | | | | |
| | | methylpropionate) | | | | | |
| 20 | 56.972 | Famesol | 0.34 | 0.42 | 0.51 | 0.43 | 0.34 |
| 21 | 58.684 | Phthalic acid 1-butyl | 0.52 | 0.66 | 0.77 | 0.73 | 0.41 |
| | | 2-isobutyl ester | | | | | |
| 22 | 59.096 | Scopoletin | 0.41 | 0.58 | 0.61 | 0.60 | 0.38 |
| 23 | 64.684 | Tributyl | 0.42 | 0.59 | 0.60 | 0.60 | 0.35 |
| | | prop-1-ene-1,2,3- | | | | | |
| | | tricarboxylate | | | | | |

| | | | | | |
|---|---|---|---|---|---|
| Total amount | 13.73 | 16.50 | 19.99 | 18.72 | 10.76 |

### EXAMPLE 4

A method for preparing a tar extract from a discarded cigarette butt included the following steps:

(1) pretreating of the discarded cigarette butt: outer wrapping paper of the discarded cigarette butt was removed, and a tow was cut into small segments with a length of less than 1 cm;

(2) 100 g of the pretreated discarded cigarette butt was added to 500 ml of anhydrous ethanol, and microwave radiation was carried out with a microwave-assisted extraction power of 40 W for 5 min to obtain an extraction solution;

(3) the extraction solution was centrifuged at 500 r/min for 3 min, the supernatant was allowed to pass through a silica gel column, elution was carried out by using a petroleum ether-ethyl acetate mixed solution (a volume ratio of petroleum ether to ethyl acetate was 2:1) as a mobile phase, and the resulting elution fraction was collected; and

(4) vacuum distillation was carried out on the elution fraction at 30° C. under a vacuum pressure of 5 mmH, and then vacuum drying was carried out at 100° C. to obtain the tar extract.

### EXAMPLE 5

A method for preparing a tar extract from a discarded cigarette butt included the following steps:

(1) pretreating of the discarded cigarette butt: outer wrapping paper of the discarded cigarette butt was removed, and a tow was cut into small segments with a length of less than 1 cm;

(2) 100 g of the pretreated discarded cigarette butt was added to 3 L of anhydrous ethanol, and microwave radiation was carried out with a microwave-assisted extraction power of 400 W for 5 min to obtain an extraction solution;

(3) the extraction solution was centrifuged at 2000 r/min for 1 min, the supernatant was allowed to pass through a silica gel column, elution was carried out by using a petroleum ether-ethyl acetate mixed solution (a volume ratio of petroleum ether to ethyl acetate was 30:1) as a mobile phase, and the resulting elution fraction was collected; and

(4) vacuum distillation was carried out on the elution fraction at 50° C. under a vacuum pressure of 0.1 mmH, and then vacuum drying was carried out at 150° C. to obtain the tar extract.

### Comparative Example 1

This comparative example was different from Example 5 in that: (3) the supernatant was allowed to pass through a silica gel column, elution was carried out by using a petroleum ether-ethyl acetate mixed solution (a volume ratio of petroleum ether to ethyl acetate was 30:1) as a mobile phase, and the resulting elution fraction was collected; and (4) the elution fraction was centrifuged at 500 r/min for 3 min, vacuum distillation was carried out on the supernatant at 50° C. under a vacuum pressure of 0.1 mmH, and then vacuum drying was carried out at 120° C. to obtain the tar extract. The rest were the same as the steps in the method in Example 5.

### Comparative Example 2

This comparative example was different from Example 5 in that: (3) the extraction solution was centrifuged at 2000 r/min for 1 min, the supernatant was allowed to pass through a silica gel column, elution was carried out by using a petroleum ether-ethyl acetate mixed solution (a volume ratio of petroleum ether to ethyl acetate was 1:1) as a mobile phase, and the resulting elution fraction was collected. The rest were the same as the steps in the method in Example 5.

### Comparative Example 3

This comparative example was different from Example 5 in that: (3) the extraction solution was centrifuged at 2000 r/min for 1 min, the supernatant was allowed to pass through a silica gel column, elution was carried out by using a petroleum ether-ethyl acetate mixed solution (a volume ratio of petroleum ether to ethyl acetate was 40:1) as a mobile phase, and the resulting elution fraction was collected. The rest were the same as the steps in the method in Example 5.

The tar extracts prepared in Examples 4-5 and Comparative Examples 1-3 were tested for their types and contents thereof. The test results showed that the types and contents of the tar extracts prepared in Examples 4-5 were greater than those of the tar extracts prepared in Comparative Examples 1-3.

The tar extracts prepared in Examples 4-5 and Comparative Examples 1-3 were respectively added to a cigarette tobacco blend in an amount of 3% of the weight of the cigarette tobacco blend to prepare a cigarette sample 1#, a cigarette sample 2#, a cigarette sample D1#, a cigarette sample D2# and a cigarette sample D3#. After the cigarette samples were equilibrated in a constant-temperature and constant-humidity environment of (20±1)° C. and (60±3)% RH for 24 h, 20 or more smoking evaluators were organized to perform sensory evaluation on the cigarette samples with reference to Tobacco in processing-Sensory evaluation methods (YC/T 415-2011). The evaluation results are shown in Table 4.

TABLE 4
Sensory evaluation results

| | | Cigarette | Cigarette | Cigarette | Cigarette | Cigarette |
|---|---|---|---|---|---|---|
| | | sample | sample | sample | sample | sample |
| Evaluation sample | | 1# | 2# | D1# | D2# | D3# |
| Aroma | Quality of | 6.00 | 6.25 | 6.00 | 6.00 | 6.00 |
| | aroma | | | | | |
| characteristics | Quantity of | 6.25 | 6.50 | 6.25 | 6.00 | 6.00 |
| | aroma | | | | | |
| | Offensive | 6.20 | 6.25 | 6.20 | 6.20 | 6.20 |
| | odor | | | | | |
| | Volatility | 6.00 | 6.00 | 6.00 | 6.00 | 6.00 |
| Smoke | Concentration | 6.25 | 6.25 | 6.00 | 6.25 | 6.25 |
| characteristics | Strength | 6.00 | 6.00 | 6.00 | 6.00 | 6.00 |
| | Harshness | 6.50 | 6.25 | 6.20 | 6.25 | 6.00 |
| | Agglomeration | 5.50 | 5.50 | 5.50 | 5.50 | 5.50 |
| Taste | Irritancy | 6.25 | 6.25 | 6.25 | 6.25 | 6.25 |
| characteristics | Dry feeling | 6.00 | 6.00 | 6.00 | 6.00 | 6.00 |
| | Clean degree | 6.00 | 5.75 | 5.75 | 5.75 | 5.75 |
| | Sweet | 5.00 | 5.00 | 5.00 | 5.00 | 5.00 |
| | aftertaste | | | | | |

As can be seen from the results in Table 4, compared with the comparative examples, after the tar extracts prepared in the examples of the present disclosure were added to the cigarette, the aroma characteristics, the smoke characteristics and the taste characteristics of the cigarette were improved to different degrees. Thus, the smoke, aroma and taste characteristics of the low-end cigarette could be effectively improved, and the sensory quality of the low-end cigarette was improved.

The above are only examples of the present application, and the protection scope of the present application is not limited by these specific examples, but is determined by the claims of the present application. For those skilled in the art, various modifications and variations can be made to the present application. Any modification, equivalent replacement or improvement made within the technical ideas and principle of the present application shall fall within the protection scope of the present application.

What is claimed is:

1. A method for preparing a tar extract from a discarded cigarette butt, comprising the following steps:
(1) adding the discarded cigarette butt to an extraction solvent, and carrying out microwave-assisted extraction to obtain an extraction solution; and
(2) centrifuging the extraction solution, carrying out silica gel column chromatography on the supernatant, carrying out elution by using a petroleum ether-ethyl acetate mixed solution as a mobile phase, and collecting the resulting elution fraction to obtain the tar extract.

2. The method according to claim 1, wherein in the step (1), the extraction solvent is at least one of methanol, anhydrous ethanol, petroleum ether, n-hexane, acetone, dichloromethane and ethyl acetate.

3. The method according to claim 1, wherein in the step (1), a ratio of the discarded cigarette butt to the extraction solvent is 1 g:5-30 mL, a microwave power is 40-400 W, and the microwave-assisted extraction is carried out for 3-10 min.

4. The method according to claim 1, wherein in the step (2), a volume ratio of petroleum ether to ethyl acetate in the petroleum ether-ethyl acetate mixed solution is 2-30:1.

5. The method according to claim 1, further comprising the steps of carrying out vacuum distillation on the collected elution fraction, and carrying out vacuum drying.

6. The method according to claim 1, further comprising a step of pretreating the discarded cigarette butt.

7. A tar extract prepared by the method according to claim 1.

8. Use of the tar extract according to claim 7 as a raw material of a flavor or in the preparation of a flavor.

9. Use of the tar extract according to claim 7 in the preparation of a cigarette.

10. The use according to claim 9, wherein the cigarette is a low-end cigarette.

11. The method according to claim 4, wherein the centrifuging is carried out at a revolution speed of 500-2000 r/min for 1-3 min.

12. The method according to claim 5, wherein the vacuum distillation is carried out at a temperature of 30-50° C. under a pressure of 0.1-5 mmH; and the drying is carried out at a temperature of 100-150° C.

13. The method according to claim 6, wherein the pretreating specifically comprises:
tearing off outer wrapping paper from the discarded cigarette butt, and cutting a tow into small segments with a length of less than 1 cm.

14. A tar extract prepared by the method according to claim 2.

15. A tar extract prepared by the method according to claim 3.

16. A tar extract prepared by the method according to claim 4.

17. A tar extract prepared by the method according to claim 5.

18. A tar extract prepared by the method according to claim 6.

19. The use according to claim 10, wherein the tar extract is added to a filter or a cigarette tobacco blend of the low-end cigarette.

20. The use according to claim 19, wherein the amount of the tar extract added is 2-5% of the weight of the cigarette tobacco blend.
